(19) United States
(12) Patent Application Publication
(10) Pub. No.: US 2025/0012635 A1
(43) Pub. Date: Jan. 9, 2025

(54) CORRECTION FOR NON-RADIATION HEAT-FLOWS IN INFRARED TEMPERATURE SENSOR

(71) Applicant: Excelitas Technologies Singapore Pte. Ltd., Singapore (SG)

(72) Inventors: Lutz Rauscher, Wiesbaden (DE); Hermann Karagoezoglu, Wiesbaden (DE); Sven Stöttinger, Mainz (DE); Prometeusz Jasinski, Ingelheim (DE)

(73) Assignee: Excelitas Technologies Singapore Pte. Ltd., Singapore (SG)

(21) Appl. No.: 18/893,215

(22) Filed: Sep. 23, 2024

Related U.S. Application Data
(63) Continuation of application No. PCT/IB2023/000176, filed on Mar. 24, 2023.
(60) Provisional application No. 63/482,766, filed on Feb. 1, 2023.
(60) Provisional application No. 63/323,243, filed on Mar. 24, 2022.

(51) Int. Cl. G01J 5/16; G01J 5/06

(52) U.S. Cl. CPC G01J 5/16; G01J 5/064; G01J 2005/066

(57) ABSTRACT

Some aspects of the technology described herein are directed to a thermal sensor and corresponding systems and methods for mitigating errors arising from non-radiative heat flow. The thermal sensor system, comprising: a thermal sensor comprising and a housing. The thermal sensor comprising: a thermal detection region of a sensor substrate; a thermal reference region of the sensor substrate; and an array of thermocouples configured to detect a thermal differential between the thermal detection region and the thermal reference region. The housing configured to support the thermal sensor within the housing and beneath a windowed aperture of the housing, wherein the windowed aperture is configured such that radiative energy may transmit through the windowed aperture and be received by the thermal sensor.

### CROSS REFERENCE TO RELATED APPLICATIONS

This application claims the benefit of and priority under 35 U.S.C. § 119 (e) to U.S. Provisional Patent Application Ser. No. “63/323,243”, filed on Mar. 24, 2022, and entitled “CORRECTION FOR NON-RADIATION HEAT-FLOWS IN INFRARED TEMPERATURE SENSOR,” and U.S. Provisional Patent Application Ser. No. “63/482,766,” filed on Feb. 1, 2023, and entitled “CORRECTION FOR NON-RADIATION HEAT-FLOWS IN INFRARED TEMPERATURE SENSOR,” each of which is incorporated by reference herein in its entirety.

### FIELD

The present application relates to radiation sensors, and more particularly, is related to infrared temperature sensors.

### BACKGROUND

In many situations it is useful to determine the temperature of a remote object by detecting and quantifying infrared radiation received at a thermal sensor from the remote object. For example, a thermal sensor may absorb the radiation received from a remote object causing radiative heat transfer to the sensor and increasing the temperature of the absorber. By detecting the change in temperature of the absorber, the sensor may quantify an amount of infrared radiation emitted from the object and by extension, may determine the objects temperature.

### SUMMARY

Some embodiments provide for a thermal sensor, comprising: a thermal detection region of a sensor substrate; a thermal reference region of the sensor substrate; and an array of thermocouples configured to detect a thermal differential between the thermal detection region and the thermal reference region.

In some embodiments, the thermal detection region comprises a first signal junction block; the thermal reference region comprises a first reference junction block; and the array of thermocouples, wherein each thermocouple in the array of thermocouples being configured to electrically couple the first signal junction block to the first reference junction block.

In some embodiments, the first signal junction block comprises a plurality of thermoelectric junctions disposed along a first line radially extending from a central region of the substrate; and the first reference junction block comprises a plurality of thermoelectric junctions disposed along a second line radially extending from the central region of the substrate.

In some embodiments, the array of thermocouples is a first array of thermocouples of a plurality of arrays of thermocouples; the thermal detection region is a first thermal detection region of a plurality of thermal detection regions; and the thermal reference region is a first thermal reference region of a plurality of thermal reference regions.

In some embodiments, a second thermal detection region of the plurality of thermal detection regions, comprises a second signal junction block disposed along a third line radially extending from the central region of the substrate, the third line being axially aligned with the first line; and a second thermal reference region of the plurality of thermal reference regions, comprises a second reference junction block disposed along a fourth line radially extending from the central region of the substrate, the fourth line being axially aligned with the second line.

In some embodiments, a second array of thermocouples configured to probe a temperature of the first signal junction block relative to the second reference junction block; a third array of thermocouples configured to probe a temperature of the second signal junction block relative to the first reference junction block; and a fourth array of thermocouples configured to probe a temperature of the second signal junction block relative to the second reference junction block.

In some embodiments, the thermal sensor further comprises radial signal thermocouples configured to detect, within the plurality of thermal detection regions, a first radial thermal differential between the central region of the substrate and a peripheral region of the substrate; and radial reference thermocouples configured to detect, within the plurality of thermal reference regions, a second radial thermal differential between the central region of the substrate and the peripheral region of the substrate.

In some embodiments, a separation between the first signal junction block and the second signal junction block across the central region is larger than a separation between the first reference junction block and the second reference junction block across the central region.

In some embodiments, a reflective layer is disposed on the thermal reference region.

In some embodiments, an absorbing layer is disposed on the thermal detection region.

In some embodiments, the array of thermocouples is configured with at least one bend of 20-80 degrees between the first signal junction block and the first reference junction block.

Some embodiments provide for a method of operating a thermal sensor to determine a quantity of radiative energy received by the thermal sensor, the method comprising: detecting, using a first array of thermocouples, a first thermal differential between a first thermal detection region and a first thermal reference region of a substrate of the thermal sensor, wherein: the first thermal detection region comprises a first signal junction block; the first thermal reference region comprises a first reference junction block; and the first array of thermocouples is configured to probe a temperature of the first signal junction block relative to the first reference junction block, such that an electrical signal detected from the first array of thermocouples is indicative of the first thermal differential between the first signal junction block and the first reference junction block; and determining the quantity of radiative energy received based on the first thermal differential between the thermal detection region and the thermal reference region.

In some embodiments, determining the quantity of radiative energy received is further based on a second thermal differential and wherein detecting the second thermal differential comprises: detecting, using a second array of thermocouples, the second thermal differential between a second thermal detection region and a second thermal reference region of the substrate of the thermal sensor, wherein: the second thermal detection comprises a second signal junction block; the second thermal reference region comprises a second reference junction block; and the second array of thermocouples being configured to probe a temperature of the second signal junction block relative to the second reference junction block, such that an electrical signal detected from the second array of thermocouples is indicative of the second thermal differential between the second signal junction block and the second reference junction block.

In some embodiments, determining the quantity of radiative energy received is further based on a third and fourth thermal differential, and wherein detecting the third and fourth thermal differentials comprises: detecting, using a third array of thermocouples, the third thermal differential between the first thermal detection region and the second thermal reference region; and detecting, using a fourth array of thermocouples, the fourth thermal differential between the second thermal detection region and the first thermal reference region.

In some embodiments, detecting a radial signal thermal differential between a central region of the substrate and a peripheral region of the substrate within the thermal detection region; and detecting a radial reference thermal differential between the central region of the substrate and the peripheral region of the substrate within the thermal reference region.

In some embodiments, the first signal junction block comprises a plurality of thermoelectric junctions disposed along a first line radially extending from a central region of the substrate; and the first reference junction block comprises a plurality of thermoelectric junctions disposed along a second line radially extending from the central region of the substrate.

Some embodiments provide for a thermal sensor system, comprising: a thermal sensor comprising: a thermal detection region of a sensor substrate; a thermal reference region of the sensor substrate; and an array of thermocouples configured to detect a thermal differential between the thermal detection region and the thermal reference region; and a housing configured to support the thermal sensor within the housing and beneath a windowed aperture of the housing, wherein the windowed aperture is configured such that radiative energy may transmit through the windowed aperture and be received by the thermal sensor.

In some embodiments, the thermal detection region comprises a first signal junction block, the first signal junction block comprising a plurality of thermoelectric junctions disposed along a first line radially extending from a central region of the substrate; the thermal reference region comprises a first reference junction block, the first reference junction block comprises a plurality of thermoelectric junctions disposed along a second line radially extending from the central region of the substrate; and the array of thermocouples, wherein each thermocouple in the array of thermocouples is configured to probe a temperature of the first signal junction block relative to the first reference junction block.

In some embodiments, the thermal detection region is a first thermal detection region of a plurality of thermal detection regions, and the plurality of thermal detection regions further comprises a second thermal detection region, comprising a second signal junction block disposed along a third line radially extending from the central region of the substrate, the third line being axially aligned with the first line; the thermal reference region is a first thermal reference region of a plurality of thermal reference regions, and the plurality of thermal reference regions further comprises a second thermal reference region, comprising a second reference junction block disposed along a fourth line radially extending from the central region of the substrate, the fourth line being axially aligned with the second line; and the array of thermocouples is a first array of thermocouples of a plurality of arrays of thermocouples, and the plurality of arrays of thermocouples further comprising: a second array of thermocouples configured to probe a temperature of the first signal junction block relative to the second reference junction block; a third array of thermocouples configured to probe a temperature of the second signal junction block relative to the first reference junction block; and a fourth array of thermocouples configured to probe a temperature of the second signal junction block relative to the second reference junction block.

In some embodiments, the thermal sensor system further comprises radial signal thermocouples configured to detect, within the plurality of thermal detection regions, a first radial thermal differential between the central region of the substrate and a peripheral region of the substrate; and radial reference thermocouples configured to detect, within the plurality of thermal reference regions, a second radial thermal differential between the central region of the substrate and the peripheral region of the substrate.

In some embodiments, the thermal sensor system further comprising a reflective layer disposed on the thermal reference region, and an absorbing layer disposed on the thermal detection region, wherein the absorbing layer is nanostructured to provide for absorption of the radiative energy, and the reflective layer is nanostructured to provide for reflection of the radiative energy.

Some embodiments provide for a thermal sensor-chip device comprising: two symmetrically arrange pairs of pixels, wherein a first pixel of each pair has a different sensitivity to incident radiation from a second pixel of each pair.

In some embodiments, the sensor-chip consists of one of the group of a thermopile, a bolometer, a pyroelectric sensor, and a photonic sensor.

In some embodiments, each pixel comprises a pixel shape or boundary configured to minimize a common-mode error signal according expected thermal transients.

In some embodiments, a sensitivity of each pixel pair is wavelength dependent.

In some embodiments, the sensor-chip comprises a thermopile chip configured to generates a signal as a function of a difference of pixel temperature.

In some embodiments, the thermal sensor-chip device further comprises having at least one thermopile structure that measures temperature between one of the pixels and the sensor's rim or body.

Some embodiments provide for a thermal sensor packaging comprising: at least one sensor chip arranged in a package cavity; a read-out circuit disposed in the cavity; and an optical window configured transparent to IR radiation of a specified wavelength range.

In some embodiments, the thermal sensor packaging further comprises a calculation unit comprising a processor and a memory configured to store non-transitory instructions that when executed by the processor configured to perform the steps of: calculating a heat-flow contributions along the sensor; and deriving a surface temperature of the package.

Some embodiments provide for a thermal sensor, comprising: a plurality of thermal detection regions; a plurality of thermal reference regions; and a plurality of sensors disposed on a substrate and configured to detect a differential signal between the plurality of thermal detection regions and the plurality of thermal reference regions.

In some embodiments, the plurality of thermal reference regions comprises a pair of thermal reference pixels.

In some embodiments, the plurality of thermal detection regions comprises a pair of thermal detection pixels.

In some embodiments, the plurality of thermal reference regions comprise reflectors configured to reflect at least a portion of received radiation.

In some embodiments, the received radiation is thermal radiation.

In some embodiments, the received radiation is infrared radiation.

In some embodiments, the received radiation is visible radiation.

In some embodiments, the reflectors comprise metal layers.

In some embodiments, the plurality of sensors comprises a plurality of thermocouples.

In some embodiments, the plurality of sensors is configured as a plurality of concentric sets of sensors.

In some embodiments, the plurality of sensors comprise a plurality of reference contacts and a plurality of sensing contacts, wherein the reference contacts are thermally coupled to a thermal reference region of the plurality of thermal reference regions, and the sensing contacts are thermally coupled to a thermal detection region of the plurality of thermal detection regions, and wherein the plurality of reference contacts and the plurality of sensing contacts are electrically coupled.

In some embodiments, the plurality of sensing contacts and the plurality of reference contacts are electrically coupled by a plurality of metallic conductors.

In some embodiments, the plurality of metallic conductors comprises metal wires.

In some embodiments, the plurality of metallic conductors comprises metallic traces.

In some embodiments, the plurality of metallic conductors is configured in an octagonal configuration.

In some embodiments, the plurality of metallic conductors is configured with at least one bend between 20 degrees and 80 degrees between the plurality of sensing contacts and the plurality of reference contacts.

In some embodiments, the spacing between a first thermal detection region and a second thermal detection region, of the plurality of thermal detection regions, is larger than the spacing between a first thermal reference region and a second thermal reference region, of the plurality of thermal reference regions.

### BRIEF DESCRIPTION OF THE DRAWINGS

The accompanying drawings are included to provide a further understanding of some embodiments of the technology described herein and are incorporated in and constitute a part of this specification. The drawings illustrate embodiments of the technology described herein and, together with the description, serve to explain the principals of the technology. In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1A is a schematic diagram of a thermopile chip.

FIG. 1B is a schematic diagram showing/depicting/of a sensor chip in a housing.

FIG. 1C is a plot illustrating signal strength depending on the sensitivity to radiation of an absorber.

FIG. 1D is a schematic diagram of a two-sensor arrangement of two sensors measuring signal difference directly, while cancelling an error component, in accordance with some embodiments.

FIG. 1E is a diagram of an exemplary method for removing the error component from a two-pixel thermal sensor, in accordance with some embodiments.

FIG. 2 is a plot of temperature distribution over a thermal sensor.

FIG. 3 is a schematic diagram of an exemplary embodiment of a thermal sensor chip with regions of different sensitivity, in accordance with some embodiments.

FIG. 4 is a plot showing temperature distribution resulting from incoming radiation of the thermal sensor chip of FIG. 3.

FIG. 5 shows side-by-side plots comparing resulting temperature distribution results from incoming radiation (left) and error sources (right).

FIG. 6 is a schematic diagram of an exemplary embodiment of a thermal sensor chip configured for correcting error signals, in accordance with some embodiments.

FIG. 7 is a schematic diagram of an exemplary embodiment of a thermopile chip with regions of high and low emissivity and thermopile structures between the regions, in accordance with some embodiments.

FIG. 8 is a schematic diagram showing a cutaway perspective view of an exemplary embodiment of a thermally compensated chip inside a surface mount device (SMD) package, in accordance with some embodiments.

FIG. 9 illustrates a perspective view of an example thermal sensor with absorbing and reflecting layers, in accordance with some embodiments.

FIG. 10 illustrates a perspective view of an example thermal sensor without absorbing layers, in accordance with some embodiments.

FIG. 11 illustrates a perspective view of an example thermal sensor with radial thermal detectors, in accordance with some embodiments.

FIG. 12A illustrates a perspective view of an example thermal sensor with angled thermal detectors, in accordance with some embodiments.

FIG. 12B illustrates a top view of an example thermal sensor with angled thermal detectors, in accordance with some embodiments.

FIG. 13 illustrates a plot showing temperature distribution resulting from incoming radiation of a symmetrical thermal sensor without absorbing layers.

FIG. 14 illustrates a top view of an example thermal sensor with a spatial offset of thermal detectors, in accordance with some embodiments.

FIG. 15A illustrates a top view of an example thermal sensor with shaped reflective layers, in accordance with some embodiments.

FIG. 15B illustrates a top view of an example thermal sensor with concentric thermopiles, in accordance with some embodiments.

FIG. 16 illustrates a top view of an example thermal sensor with nanostructured absorbing and reflective layers, in accordance with some embodiments.

Reference will now be made in detail to embodiments of the technologies described herein, examples of which are illustrated in the accompanying drawings. Wherever possible, the same reference numbers are used in the drawings and the description to refer to the same or like parts.

### DETAILED DESCRIPTION

The inventors have developed technologies to facilitate the detection of radiative heat that can mitigate the errors resulting from non-radiative heat-flows. The technologies described herein provide a thermal sensor with corresponding systems and methods that may be used to implement a temperature sensor. Temperature sensors may be configured to determine the temperature of an object based on the heat detected by a thermal sensor integrated with the temperature sensor. Temperature sensors may receive both radiative and non-radiative heat. However, for some applications, the determination of the temperature of an object is based on the radiative heat received from the object. Accordingly, the non-radiative heat received by the sensor may produce noise and/or errors in determining the temperature of the object. Temperature sensors implemented using embodiments of the technologies described herein may facilitate a determination of the temperature of an object based on received radiation that may mitigate the noise and/or errors associated with non-radiative heat.

Thermal sensors (e.g., radiative thermal sensors) operate by absorbing thermal radiation, such as infrared radiation, such that the absorbing portion of the sensor increases in temperature. By configuring the components of the sensor to detect the change in temperature of the absorbing region, the quantity of thermal radiation received can determined based on the change in temperature and the thermal properties of the absorbing region. Accordingly, non-radiative heat which is absorbed by the absorbing region, such as through convection and/or conduction from the surroundings, will similarly cause the thermal sensor to increase in temperature. Thus, changes in temperature of the thermal sensor due to non-radiative heat may cause errors in determining the quantity of thermal radiation received.

According to some aspects of the technology described herein, a semiconductor die substrate that includes the thermal sensor is packaged for use in a mobile device. The inventors have further recognized and appreciated that the size of electronics packages for mobile devices provides challenges for the detection and quantification of thermal radiation. For example, one technique which can be used to reduce the flow of non-radiative heat to the sensor is to package the thermal sensor in an oversized housing such that the clearance between the walls of the package and the thermal sensor is larger, thus providing for increased spatial isolation between the sources of non-radiative heat and the sensor. However, when the package is sized for mobile applications, the clearance between the thermal sensor and the package walls is small and thus provides for an increase in the non-radiative thermal transfer both through the air gap between the housing and the thermal sensor and through the packaging itself.

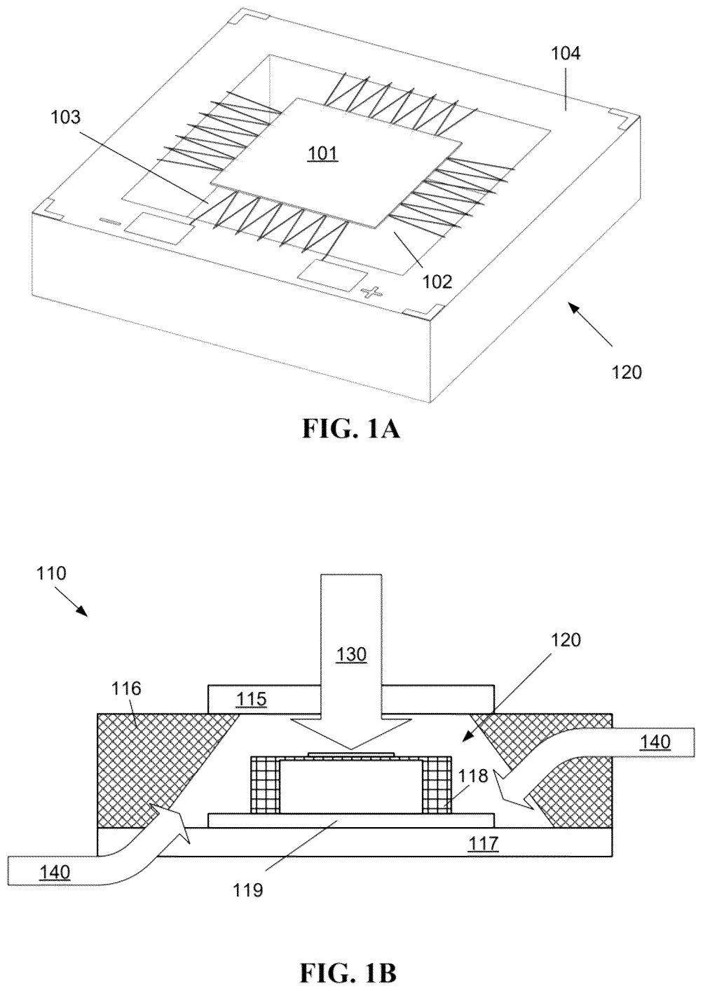

The inventors having recognized and appreciated the challenges described above have accordingly developed thermal sensors to mitigate the noise and/or errors caused by non-radiative heat in the determination and quantification of radiative heat. The thermal sensors include an array of thermocouples configured to detect the difference in temperature between at least one thermal detection region and at least one reference region. The difference in temperature between the at least one thermal detection regions and the at least one reference region may be used to isolate components of the detected signal that are due to the radiative heat flow from the components of the detected signal that are due to non-radiative heat flow and thus mitigate the impact of the non-radiative heat flow on the quantification of radiative heat flow received by the sensors, as described further herein in connection with FIGS. 1C-1E. The thermal sensors may also include additional thermal and reference regions with additional arrays of thermocouples. For example, the thermal sensor may include two thermal detection regions and two reference regions which may each be arranged such that each thermal detection region is bordered by two reference regions (e.g., in a checkerboard pattern).

Thermocouples are sensors comprising two different conductors, such as metals or doped semiconductors, with a hot junction and a cold junction, each of which may be considered thermoelectric junctions. When there is a temperature difference between the hot and cold junctions, a voltage is created through the conductors which is proportional to the magnitude of the temperature difference (e.g., proportional to the temperature differential between hot and cold junctions). Generally, the hot junction is used as a probe to detect or sense a temperature and the cold junction is used as a reference against which the probe is measured. The two conductors are generally electrically coupled to each other at the hot junction and electrically coupled to the measurement circuit at the cold junction. The measurement circuit may be a thermopile that includes an array of thermocouples, such that at the cold junction, the two conductors are electrically coupled to the output of a preceding thermocouple and the input of a successive thermocouple. As described herein, a thermopile is a circuit including one or more thermocouples and circuitry configured to combine the output of the one or more thermocouples to quantify a voltage and or current produced by the one or more thermocouples. Other thermocouple configurations are possible and may be used in connection with the embodiments described herein, as aspects of the technology described herein are not limited in this respect.

In some embodiments, the two different conductors may be two different semiconductors. For example, the two different semiconductors may be p-type doped silicon and n-type doped silicon. In some embodiments, the two different conductors may be two different metals. For example, the two different metals may be a Type E, Type J, Type K, Type M, Type N, Type T, Type B, Type R, Type S, Type C, Type D, Type D, or Type G. In other embodiments, other semiconductors and/or metals may be used, as aspects of the technology described herein are not limited in this respect.

Accordingly, some embodiments provide for a thermal sensor system comprising a thermal sensor comprising: a thermal detection region of a sensor substrate (e.g., an area on a semiconductor die and/or integrated circuit for which temperature changes are indicative of a radiative heat flow); a thermal reference region of the sensor substrate (e.g., an area on the semiconductor die and/or integrated circuit for which temperature changes are indicative of a non-radiative heat flow); an array of thermocouples configured to detect a thermal differential (e.g., the difference in temperature) between the thermal detection region and the thermal reference region; and a housing (e.g., a semiconductor package and casing) configured to support the thermal sensor within the housing beneath a windowed aperture (e.g., an opening of the housing covered by a window) of the housing, wherein the windowed aperture is configured such that radiative energy may transmit through the windowed aperture and be received by the thermal sensor.

The techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

Aspects of the technology described herein are drawn to devices and methods for correcting the response of an IR radiation temperature sensor against errors resulting from non-radiation heat-flows. In general, the embodiments employ sensors having several radiation sensitive areas (e.g., pixels or regions) with known, but varying sensitivity to radiation. The geometry of the pixel (e.g., layers of absorbing or reflecting material above the thermal sensing components) arrangement is used to ensure that the radiation sensitive areas have a well-known sensitivity to error related non-radiation heat flow.

Under some exemplary embodiments described herein a thermal sensor—that is sensitive to far infrared radiation (FIR), is used to remotely determine the temperature of an object by quantifying the energy exchange of the radiation between object and the sensor. In some of the exemplary embodiments, the sensor may be based on thermopile technology.

Two bodies of different temperature may exchange an energy or heat flow in the form of thermal radiation, which is in the infrared (IR) or far infrared (FIR) spectrum around room temperature. This heat flow is used to determine an object's temperature by exposing a reference body, called an absorber, with well-known temperature and physical properties, to radiation (e.g., IR or FIR light) received from the object. The resulting radiative heat flow Q′r is quantified by the Stefan-Boltzmann law and often a simplified version is given, where one of the objects is much smaller than the other (usually the sensor):

$${Q}_{r}^{′} = k ϵ ( {T}_{a}^{4} - {T}_{0}^{4} ) , \qquad ( Eq . l )$$

where k summarizes physical and geometric properties, ϵ is the emissivity that represents the ability of the absorber to convert thermal radiation to heat, and Tₐ and Tₒ refer to the absorber and object temperature, respectively. Tₐ is also called the ambient temperature as the sensor's absorber is usually in thermal equilibrium with its surroundings.

The absorbed heat flow is measured within the sensor and the object temperature can be calculated according to Eq. 1. This is usually done by coupling the absorber to a heat sink having a well-defined thermal resistance. The temperature difference between absorber and heat sink is then linearly proportional to the heat flow and to Q′ᵣ. Such a sensor may be, for example, a thermal sensor type, such as a thermopile, bolometer structure, and if the incoming radiation is modulated, a pyroelectric sensor. The sensor may also be of a photonic type, such as a semiconductor sensor.

As the sensor is based on the measurement of heat flow, usually by the means of measuring temperature differences, it is easily disturbed by non-radiation heat flows or temperature changes from outside the sensor and the sensor housing, respectively. The signal changes induced by these disturbances are usually referred to as error signals. The heat flow that is equivalent to the error signal shall be labeled Q′ₑ henceforth.

The following description uses the example of thermopile sensors, but the fundamental principle holds true for other sensors.

FIG. 1A gives a practical implementation for such a sensor with the absorber 101 centered on a membrane 102 made from dielectric layers like quartz of a few microns thickness, which is covering a frame 104 that functions as a heat reservoir. The membrane establishes the thermal resistance across which the temperature difference is measured by using thermocouples 103 that are arranged back and forth across the membrane 102. A temperature difference along the thermocouples results in an easily quantifiable voltage between the positive (marked +) and negative (marked −) legs of the thermopile. Alternative methods include resistive temperature sensors (bolometer) or temperature sensitive diodes. In this arrangement, measuring the temperature difference between reservoir 104 and absorber 101 may be used to determine Q′ᵣ.

The absorber and thermal resistor do not need to be separate parts. If the membrane itself absorbs at least some radiation it will result in a measurable temperature difference between the inner part of the membrane 102 and the heat sink 104, that is proportional to the absorbed energy. The resulting effects and temperature distributions do not differ fundamentally. For simplicity, the following description refers to absorber and thermal resistance in the form of a membrane as separate parts.

The above describes a sensor that is isolated against its environment. As mentioned above, in practice a sensor may receive or emit additional heat, that results in an error signal contribution Q′ₑ. As Q′ₑ limits the sensor accuracy and reproducibility, it is desirable to minimize its contribution. Usually this is done by thermally isolating the sensor to make Q′ₑ negligible. The smaller and more integrated the sensor, this becomes impractical. The signal contributed by Q′ₑ may be compensated for or quantified for later consideration.

FIG. 1B is a schematic diagram of a sensor 120 in a housing 110. The sensor 120 includes a sensor die 118 mounted on an evaluating circuit 119 that is in turn mounted on a printed circuit board (PCB) substrate 117. The housing 110 includes a cap 116 with a base portion mounted to the PCB 117 and an entrance window 115 that is at least partially transparent to infrared (IR) radiation 130. While the sensor 120 is intended to produce an output signal based on the IR radiation 130, heat flows 140 may enter the housing 110 and be sensed by the sensor die 118. Thus, heat flows 140 may cause the sensor 120 to produce a signal providing an inaccurate reading of the IR radiation 130.

Miniaturization of the housing and motivations to keep the assembly reasonably simple make these errors increasingly hard to control. Therefore, there is a need in the industry to address one or more of the abovementioned shortcomings.

As described above, thermal sensors are generally prone to error signals, such that the sensor-chip not only sees the targeted object, but e.g., also an error signal that originates from inside of the detector package. Heat sources or heat sinks surrounding the sensor may lead to undesirable temperature changes or gradients over the package, thus changing the output signal.

The embodiments include a sensor device and exemplary methods that compensate for or minimize aforementioned thermally induced error-signals in order to increase the measurement accuracy, in particular, a method for (1) producing a radiation signal Q′ᵣ and at least one error or reference signal Q′ₑ by a radiation sensor, and (2) a method for receiving Q′, and Q′ₑ from the radiation sensor (following a calibration of the sensor) and correcting Q′ᵣ based on Q′ₑ.

The term “error signal” may refer to an output of a thermal sensor due to thermal energy from a source other than a target source being monitored.

As shown in FIG. 1E, a first pixel (e.g., a thermal detection region) and a second pixel (e.g., a thermal reference region) are exposed to both Q′ᵣ and Q′ₑ, as shown by block 510. The first pixel is highly sensitive to radiation as shown by block 520, and the second pixel is less sensitive to radiation, as shown by block 530. The difference is taken of the signal outputs of the first and second pixels, as shown by block 540. The result eliminates or reduces the error signal Q′ₑ, resulting in a differential signal proportional to Q′ᵣ, as shown by block 550.

The arrangement shown in FIG. 1B may have two main sources of error. The first error source is a change in temperature of the entire package 110. The second error source is thermal conduction from the housing; in particular when applying a temperature gradient to the housing. Such a temperature gradient may occur if the sensor 120 is placed in a device with heat sources (e.g., a processor in a mobile device) or from the environment outside the housing 110 if the object to be measured is heating the housing, in particular when the object is allowed to touch the device. These and/or other, similar contributions may occur simultaneously, and the net effect may be summarized as an error-signal heat flow Q′ₑ that represents the sum of the heat flows that are not related to the target radiation signal. The sensitivity of an arrangement in FIG. 1A regarding thermal radiation depends directly on the ability of the absorber to convert the radiation into heat as described in Eq. 1. The ability of materials to convert thermal radiation is a physical property called absorption-coefficient or emissivity ϵ and ranges from less than 5% for some metals (Al, Au, Ag, etc.) to more than 95% for organic, carbon rich materials.

If a material with reduced emissivity is used to form the absorber, the sensor becomes less sensitive to radiation proportional to change in emissivity. However, this does not change the sensitivity of the sensor to error signals if the arrangement is left unchanged otherwise, i.e., heat capacity, sensor size and shape, and the housing, respectively. FIG. 1C illustrates the signal strength depending on the sensitivity to radiation of the absorber. The sensitivity of the absorber to radiation may include the optical properties relating to how radiation at wavelengths of interest interact with the material, such as the material emissivity. A low emissivity sensor 401 delivers a significantly lower signal than the highly absorbing sensor 402. If the optical properties of the sensors are known or determined in a calibration process, then the slope of the dependency in FIG. 1C is also known, and the signal difference 411 can be used to calculate the intercept and therefore the Q′ₑ contribution to the signal. The method may be extended to use of several sensors with varying properties and include their data 412 to increase accuracy.

FIG. 1D illustrates an arrangement of two sensors 401 and 402 to measure the signal difference 411 directly, while the contribution of Q′ₑ cancels out. The effectiveness and accuracy of such an arrangement may depend on matching thermal conditions for both sensors, for example, their thermal coupling to the environment, their exposure to the same thermal gradients, and their exposure to the radiating object. The thermal condition is mostly related to the geometric arrangement of the sensors. For example, an arrangement in mirror-symmetry of sensors matching in size and shape provides matching thermal conditions. In some applications, the use of more than one sensor chip is not desirable in terms of cost and size and because the thermal symmetry is easily disturbed. The present embodiment gives an example of an integrated arrangement of two or more sensing elements into one integrated circuit. For some applications, it may be desirable to provide equal or near equal sensitivity to errors for each sensing element. Therefore, symmetry considerations of the thermal distribution within the sensor can impact performance.

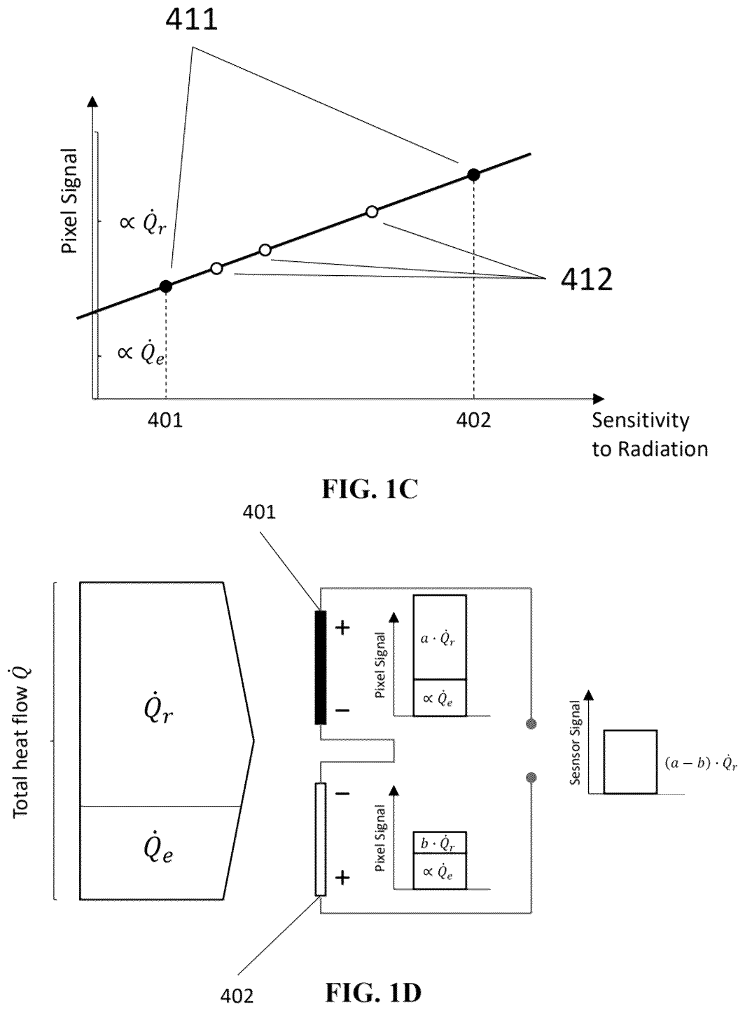

For the sensor in FIG. 1A, the thermal resistance is concentrated in the membrane 102. Heat flowing in or out of the absorber 101 is causing a heating or cooling of the absorber and accordingly a temperature gradient within the membrane. This is independent of the mechanism through which the heat is transferred, e.g., radiation, convection, or conduction. In particular it does not depend on whether the heat flow originates from Q′ᵣ or Q′ₑ. FIG. 2 gives an example of a typical temperature distribution of the top side of a sensor, where isothermal lines reflect the symmetry of the geometry.

As shown in FIG. 2, the absorber 101 from FIG. 1A is located within box 210 of FIG. 2. The membrane around the absorber is characterized by a radial thermal gradient 220 and the frame, which may act as a heat sink, is shown as cold-relative to the membrane—in region 240.

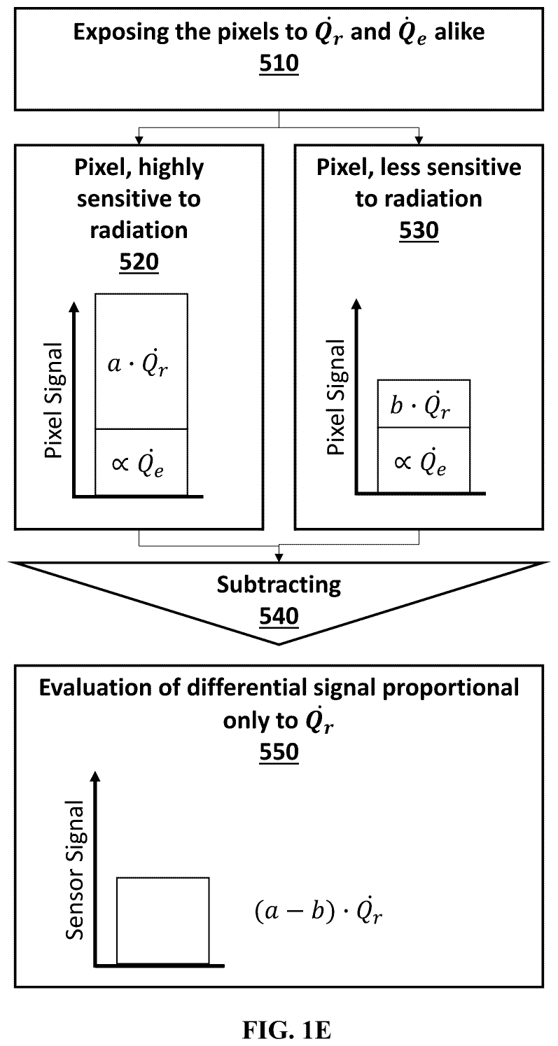

In contrast, the exemplary method embodiments minimize the error by leveraging variations in optical properties of the sensor which influence heat flow and thermal pattern of the sensor. Dividing the absorber into several areas (pixels or regions) allows variation of the sensitivity to radiation within individual zones of the membrane by varying the absorbers emissivity ϵ for different zones. The resulting heat flow by radiation into the sensor therefore becomes non-uniform. FIG. 3 shows an exemplary embodiment of a thermal sensor 300 having a pair of sensitive (absorber, high emissivity) pixels 350 (i.e., thermal detection regions) combined with a pair of low sensitivity (reflective, low emissivity) pixels 360 (i.e., thermal reference regions), in accordance with some embodiments. Alternative embodiments may have a different number of sensitive pixels 350 and/or reflective pixels 360.

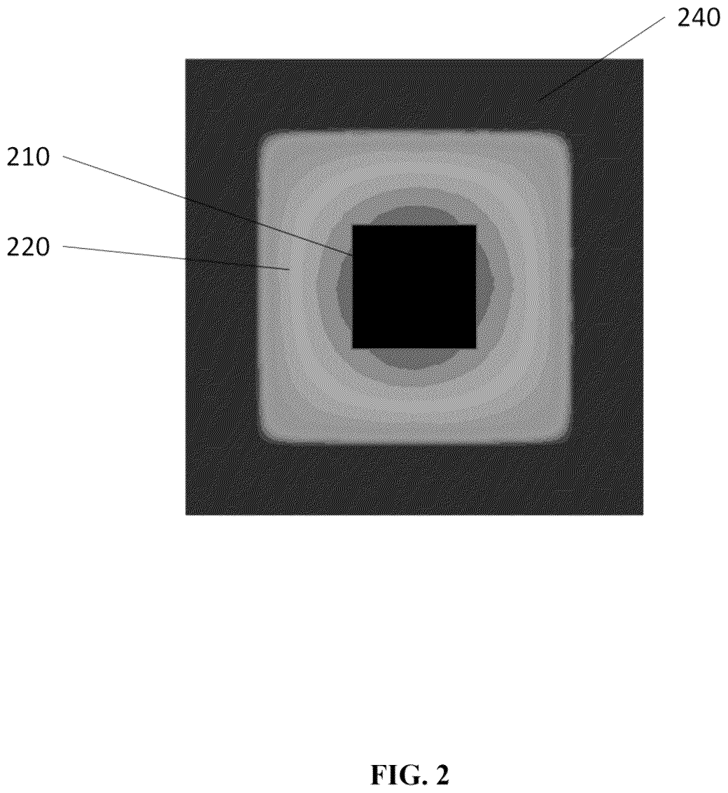

The thermal differential-resulting from the different energy absorption of received radiation between the sensitive pixels, in the thermal detection regions, and the reflecting pixels, in the thermal reference regions-results in a temperature distribution, such as the example temperature distribution shown in FIG. 4. Here, except for the optical properties of the absorber, the arrangement maintains the symmetry of the conventional sensor. Therefore, the temperature distribution imprinted by Q′ₑ (130, 140 (FIG. 1B)) does not change.

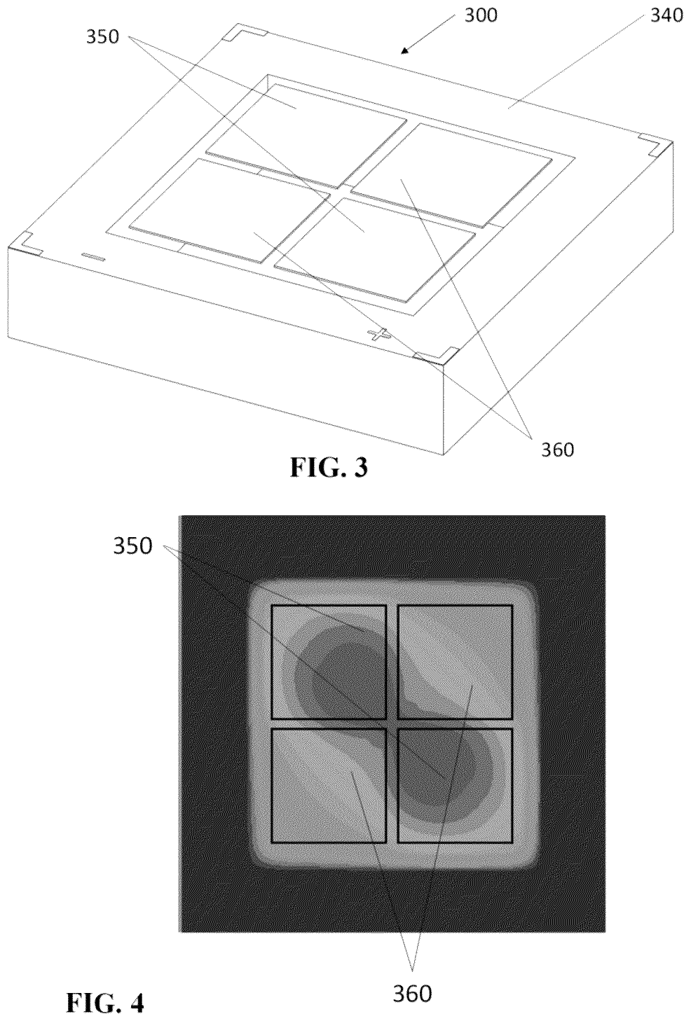

FIG. 5 contrasts the temperature distribution resulting from radiation Q′ᵣ (left plot, plot 500) and the distribution that origins in the error signal Q′ₑ (right plot, plot 502). The distributions superpose each other in the presence of both, Q′ᵣ and Q′ₑ, without influencing each other. Along the symmetry axis (shown in FIG. 5 as diagonal lines 504a and 504b) Q′ₑ contributes to the overall temperature distribution as a function of the distance from the center only. At a given distance, the contribution of Q′ₑ is substantially the same in all four corners. Therefore, the temperature difference between two points with the same distance from the center represent only the contribution of Q′ᵣ and effectively suppresses the error signal.

Since the effect of this arrangement assumes pixels 350 and 360 have the same thermal conductivity, the pixel materials may be chosen to produce similar thermal conductivities between the absorbing and reflecting layers of pixels 350 and 360, respectively. If desired, differences in thermal conductivity can be compensated by choosing an appropriate material thickness, e.g., thin layers for low emissivity, high thermal conductivity materials like aluminum or gold and thicker layers for high emissivity, low conductivity materials like black carbon. The ratio of the layer thickness may correspond to the ratio of the thermal conductivity.

A sensor as shown in FIG. 3 effectively combines two pairs of sensors described in FIG. 1D and the compensation described therein may be implemented with the advantage that the thermal symmetry conditions, described according to the embodiment in FIG. 1D, are built into the sensor of the embodiment FIG. 3.

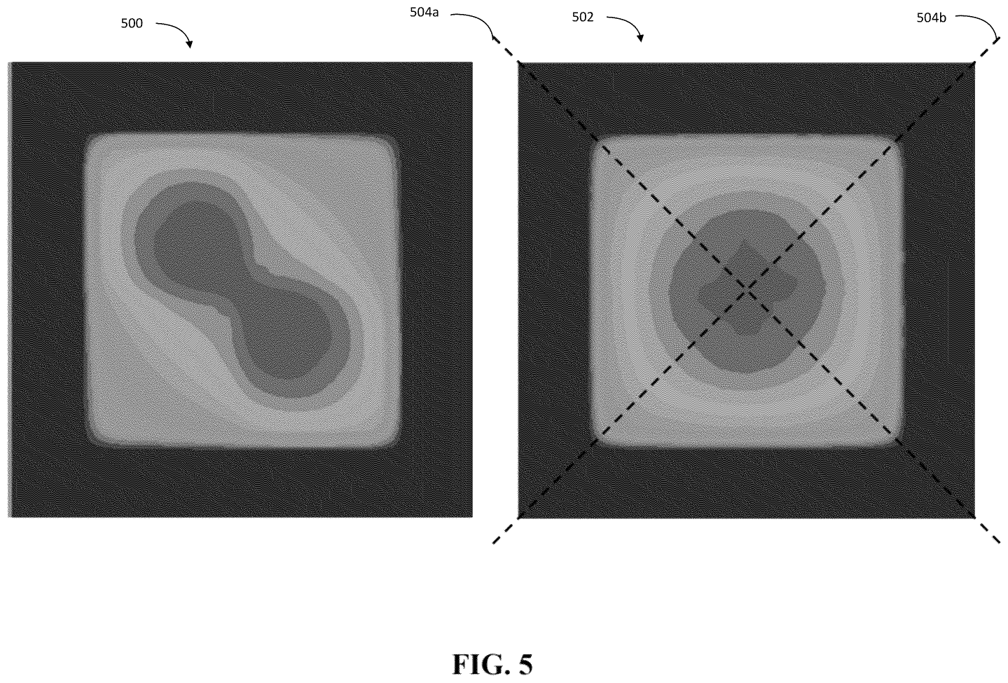

In some embodiments, the signal may no longer be derived by subtracting the signal of individual pixels that is equivalent to the temperature difference between the individual absorber and the heat sink. Instead, the difference between individual pixels, along the symmetry lines of the temperature distribution may be used, as shown by FIG. 6, in accordance with some embodiments.

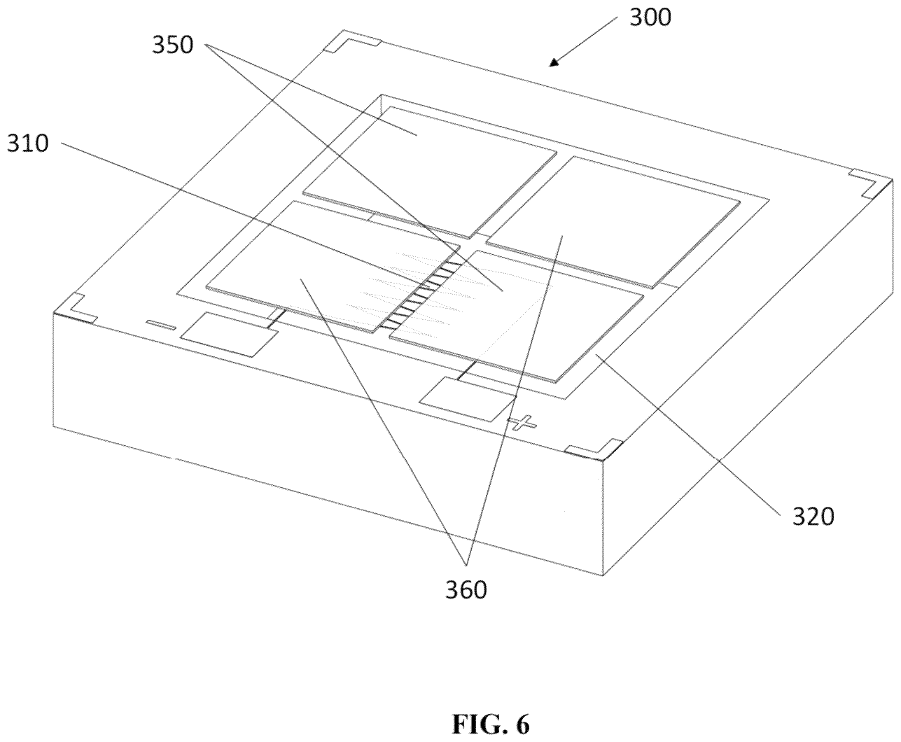

The pixel arrangement may be extended to measure the temperature difference for neighboring pixel pairs. Under favorable conditions, the thermopiles may be daisy-chained so that the difference between pixels is summed, while offsets are canceled out, in particular the contribution of Q′ₑ, as shown by FIG. 7.

FIG. 7 is a schematic diagram of an exemplary embodiment of a thermopile chip with regions of high and low emissivity and thermopile structures between the regions, in accordance with some embodiments. Thermal sensor 300 includes thermal detection regions 350, thermal reference regions 360, thermopiles 310, membrane 320, and frame 340. As described further below, thermopiles include a plurality of thermocouples which may be configured in an array to detect a relative temperature differential between the thermal detection regions and thermal reference regions.

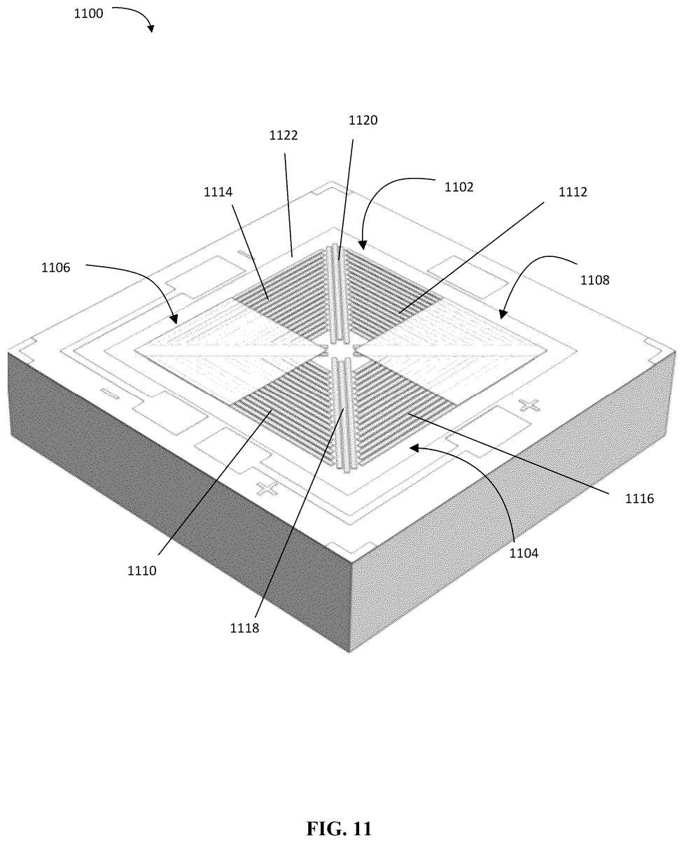

In alternative embodiments, the number of pixels may be increased to gain higher signal levels, or reduced to one pair for a smaller sensor. This arrangement may be combined with thermopile structures that measure the radial temperature difference between membrane 320 center and the sensors heat sink 340—as described further below in connection with FIG. 11. The use of thermopiles in combination with the signal of neighboring pixels provides sufficient information to determine Q′ₑ. This technique be used to correct for remaining errors that may arise from non-ideal symmetry or mismatched material properties. Additional thermopile structures between membrane and sensor rim may also be used to distinguish between a changing object's temperature and changing ambient conditions; for example, to determine stable conditions indicating signal readiness for measurement.

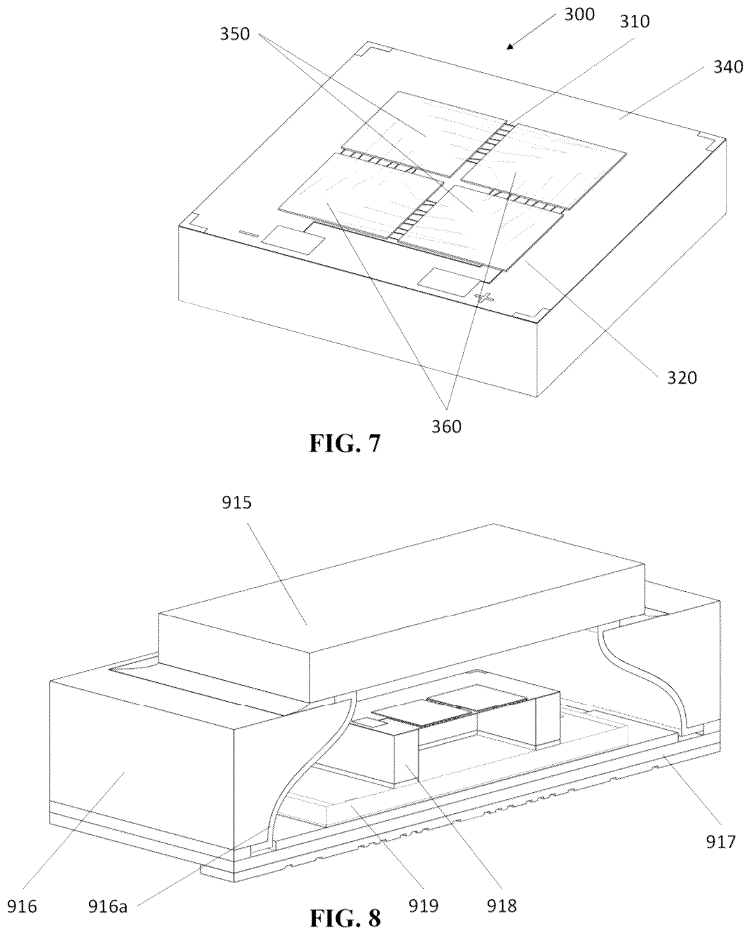

While the above embodiments describe absorbing and reflective pixels, alternative embodiments may use different pixel schemes. For example, pixels may be selected according to sensitivity to a selected range of wavelengths. For example, using pixels having sensitivities to different regions of the radiation spectrum may allow distinguishing heat exchange from moderately warm bodies (around room or body temperature, “non-glowing”) and light sources of visible wavelength. In some embodiments, wavelength discrimination may be used to distinguish between radiation received by the sensitive chip areas coming (a) through an entrance window of the sensor and (b) through the inner walls of the package. The package window 915 (FIG. 8) may use an IR filter with a long-pass characteristic, so it is only transparent for radiation above a certain wavelength. A cut-off value between 5 and 6 μm or another cut-off value may be chosen. The radiation from the inside walls of the package may have a broadband spectral characteristic.

FIG. 8 is a schematic diagram showing a cutaway perspective view of an exemplary embodiment of a thermally compensated chip inside a surface mount device (SMD) package, where the balanced thermopile chip is assembled into an SMD housing, in accordance with some embodiments. The sensor die 918 sits on a read-out circuit 919. Both chips are mounted on a substrate 917 to establish the SMD. A cap 916, which has a high-emissive interior surface 916a together with a window with window cover or filter 915 forms the cavity over the sensor 918.

In some embodiments, the window 915 may be retained in the aperture of the housing through which the sensor receives radiation. In some embodiments, window 915 may include at least one optically active surface. For example, window 915 may include an optically active surface configured to modify and/or select the polarization of light which is transmitted through the surface. In some embodiments, the window 915 may be configured to provide for wavelength selectivity. For example, window 915 may include a coating or composition to permit wavelengths of interest to transmit through the window while absorbing or reflecting wavelengths which are not of interest. In some embodiments, window 915 may include an anti-reflective coating. In some embodiments, window 915 may be combined with or substituted for a curved optical element, such as a lens configured to modify the convergence of light received by the sensor. In some embodiments, window 915 may include a protective coating. For example, window 915 may include a diamond-like carbon (DLC) coating which may provide a degree of anti-reflectivity while also providing resistance to external stresses.

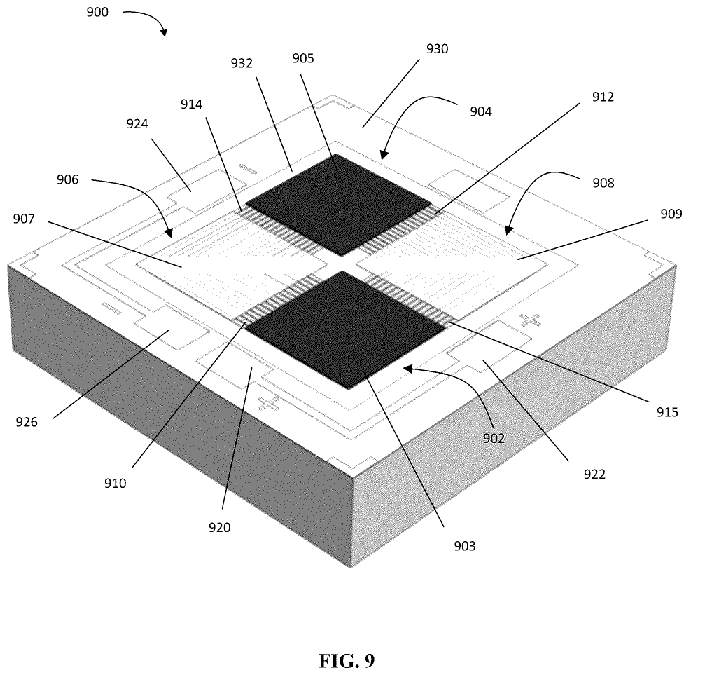

FIG. 9 illustrates a perspective view of an example thermal sensor 900 with absorbing and reflecting layers, in accordance with some embodiments. Thermal sensor 900 may be configured the same as thermal sensor 300, where the thermal detection regions include absorbing layers 903 and 905 and the thermal reference regions include reflecting layers 907 and 909. As shown in FIG. 9, thermal sensor 900 includes first thermal detection region 902, second thermal detection region 904, first thermal reference region 906, second thermal detection region 908, and a plurality of thermocouple arrays 910, 912, 914, 915. The thermal detection regions, thermal reference regions, and the plurality of thermocouples are disposed on a thermally insulative substrate membrane 932 which thermally insulates the components 902-918 from the frame 930.

As shown in FIG. 9, the thermal detection regions are 902 and 904 are covered with absorbing layers or pixels 903 and 905 which may increase the emissivity by increasing the absorption of radiative heat, as described herein. Similarly, the thermal reference regions 906 and 908 are covered with reflecting layers or pixels 907 and 909 which decrease the emissivity by reflecting radiative heat, as described herein.

In some embodiments, the absorbing layers 903 and 905 may be formed of a carbon-based material. In some embodiments, the absorbing layers 903 and 905 may be formed of a metallic material that has an absorbing layer applied to the top surface (e.g., an absorbing paint or deposited material). For example, photoresist filled with carbon black may be used to form the absorbing layers. As another example, black silicon may be used to form the absorbing layers.

In some embodiments, the reflecting layers 907 and 909 may be formed of a reflective metal such as Al, Ag, Au, or other metallic material which has been polished to have a high degree of reflectivity at a wavelength of interest. In some embodiments, a high degree of reflectivity is greater than 85%, greater than 90%, greater than 95%, or greater than 99%. In some embodiments, the reflecting layers may be formed of nanostructured materials.

A first thermocouple array 910 is configured to detect a temperature change between first thermal detection region 902 and first thermal reference region 906. A second thermocouple array 912 is configured to detect a temperature change between second thermal detection region 904 and second thermal reference region 908. A third thermocouple array 914 is configured to detect a temperature change between the second thermal detection region 904 and the first thermal reference region 906. A fourth thermocouple array 915 is configured to detect a temperature change between the first thermal detection region 902 and the second thermal reference region 908.

In some embodiments, one or more arrays of the plurality of thermocouple arrays may be electrically coupled as a single thermopile such that the thermal sensor 900 may have a singular output. In other embodiments, one or more arrays of the plurality of thermocouple arrays may be configured such that its output is individually detected by the thermal sensor, e.g., configured as a plurality of thermopiles. In some embodiments, the outputs of the thermocouple arrays may be mathematically combined to produce sums and/or averages of the signals produced therein. For example, the outputs may be mathematically combined using analog circuit elements. As another example, the outputs may be mathematically combined digitally by the thermal sensor or another circuit that performs the computation.

In some embodiments, the frame 930 may have a plurality of electrical contacts for detecting the signal of the plurality of thermocouple arrays. For example, electrical contacts 920, 922, 624, 926 may be electrically coupled to the plurality of thermocouple arrays and configured to measure one or more voltage responses indicative of thermal differentials produced by the plurality of thermocouple arrays.

In some embodiments, the frame of the substrate may act as a heat sink that may absorb and dissipate the heat received by the membrane, detection, and reference regions of the sensor. In some embodiments, the substrate membrane 932 may provide a heat sink through which excess energy from the detection and reference regions is transferred to the frame of the device. In some embodiments, the substrate membrane 932 may provide a reservoir through which energy that is received from the object is collected or absorbed such that it may be detected by one or more arrays of thermocouples. In some embodiments, the substrate membrane 932 may function both as a heat sink and reservoir, as described herein.

The inventors have recognized and appreciated that while the inclusion of absorbing layers provides advantages for some applications by increasing the absorption of radiative heat, inhomogeneities in the thermal properties of the absorbing layers may lead to differences in the thermal properties of the absorbers which, for some applications, may introduce errors into the detection of radiative energy received by the sensor. Accordingly, the inventors have developed some embodiments without the absorbing layers to mitigate the challenges and costs associated with inhomogeneities in the thermal properties of the absorbing layers. While the absorber-free embodiments may be beneficial for some applications, the inclusion of the absorbing layers may be more beneficial for other applications. For example, in embodiments which include absorbing layers formed from photoresist with carbon black, the heat capacity of the absorbers may cause the system to have a slower response to changes in the quantity of heat received relative to the absorber-free embodiments. As another example, in embodiments which include absorbing layers, the available processing tolerance regarding the thickness of the absorbers may be related to the achievable signal to noise and by extension may relate to the suitability of including absorbing layers for some applications.

In absorber free embodiments, regions of the insulating membrane may be used in conjunction with the thermocouple junctions as a probe to detect radiative heat. While the membrane may have a lower emissivity than the absorber layers, the membrane will absorb more radiative heat than the reflectors in the thermal reference regions. Accordingly, the quantity of radiative heat may be determined as described above in connection with Equation 1 and FIGS. 1C-1E. In some embodiments, the membrane may include layers of silicon oxide and/or silicon nitride. In some embodiments, the membrane may include a plurality of layers which are configured to optimize strain in the structure. For example, the materials and arrangement of the membrane layers may be configured to mitigate strain induced in the membrane from temperature changes and/or thermal gradients.

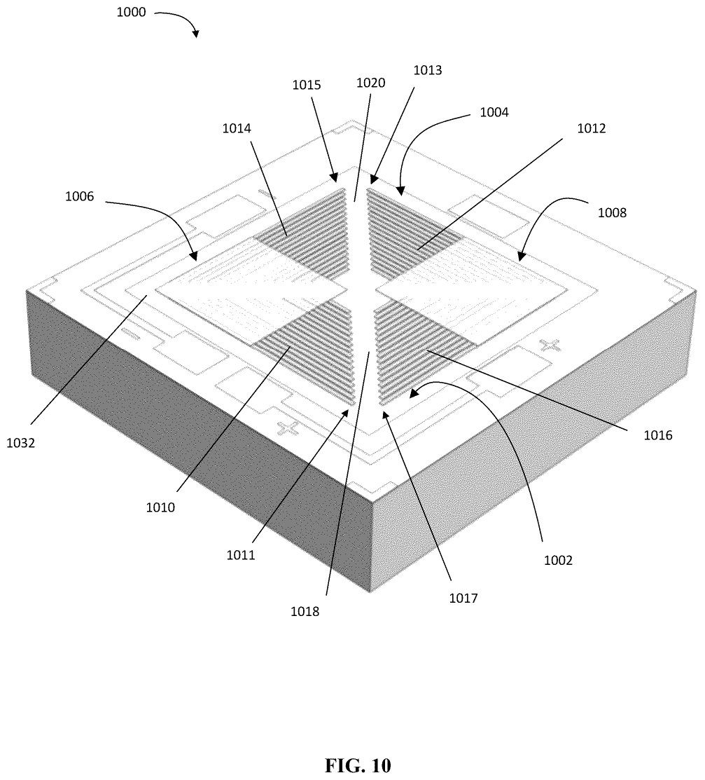

FIG. 10 illustrates a perspective view of an example thermal sensor 1000 without absorbing layers, in accordance with some embodiments. Thermal sensor 1000 may be configured the same as thermal sensor 900 but with the exception that thermal sensor 1000 does not include thermal absorbing layers. As shown in FIG. 10, thermal sensor 1000 includes first thermal detection region 1002, second thermal detection region 1004, first thermal reference region 1006, second thermal detection region 1008, and a plurality of thermocouple arrays 1010, 1012, 1014, 1016. The thermal detection regions, thermal reference regions, and the plurality of thermocouples are disposed on a thermally insulative membrane 1032 which thermally insulates the components 1002-1017 from the frame 1030.

Without the absorbing layers the membrane 1032 of the substrate and arrays of thermocouples in the thermal detection regions may act as absorbers to provide for the detection of radiative thermal energy received by the sensor. In some embodiments, the membrane and the arrays of thermocouples in the detection regions may absorb between 50-90% of incident radiative thermal energy. For example, the membrane and arrays of thermocouples in the detection regions may absorb approximately 70% of incident radiative thermal energy.

As shown in FIG. 10, each thermocouple in the array of thermocouples is configured such that the hot junctions of the thermocouples are aligned in a line that extends axially from a central region of the substrate to a peripheral region of the substrate. Each of the hot junctions for a single array of thermocouples can be treated as signal junction block which includes each of the hot junctions which probe the temperature of the signal detection region. In some embodiments, first thermal detection region 1002 includes a first array of thermocouples 1010 and a second array of thermocouples 1016. The first array of thermocouples being coupled to first signal junction block 1011 such that each hot junction of the first array of thermocouples is disposed along the first signal junction block. The second array of thermocouples being coupled to a second signal junction block 1017 such that each hot junction of the second array of thermocouples is disposed along the second signal junction block. Additionally, second thermal detection region 1004 includes a third array of thermocouples 1012 and a fourth array of thermocouples 1014. The third array of thermocouples being coupled to third signal junction block 1013 such that each hot junction of the third array of thermocouples is disposed along the third signal junction block. The fourth array of thermocouples being coupled to a fourth signal junction block 1015 such that each hot junction of the fourth array of thermocouples is disposed along the fourth signal junction block.

A corresponding set of reference junction blocks may be configured in the first and second thermal reference regions 1006 and 1008, respectively. Accordingly, the first array of thermocouples may be configured to probe a temperature of the first signal junction block 1011 relative to a first reference junction block of the first thermal reference region 1006. The second array of thermocouples 1016 may be configured to probe a temperature of the second signal junction block 1017 relative to a second reference junction block of the second thermal reference region 1008. The third array of thermocouples 1012 may be configured to probe a temperature of the third signal junction block 1013 relative to a third reference junction block of the second thermal reference region 1008. The fourth array of thermocouples 1014 may be configured to probe a temperature of the fourth signal junction block 1015 relative to a fourth reference junction block of the first thermal reference region 1006.

In some embodiments, the first signal junction block 1011, the second signal junction block 1017, third signal junction block 1013, and fourth signal junction block may be axially aligned. For example, as shown in FIG. 10, signal junction blocks 1011, 1013, 1015, and 1017 are all aligned with an axis in the plane of the sensor that traverses the absorbing portions of the membrane 1018 and 1020 through the region of the substrate.

Additionally, in some embodiments, the first, second, third, and fourth reference junction blocks associated with the first and second thermal reference regions 1006 and 1008 may be axially aligned. In some embodiments, the axial alignment of the reference junction blocks may be approximately perpendicular to the axis of the signal junction blocks.

As describe above in connection with FIG. 4, the radiation heat flow may generate a radial thermal distribution across the substrate membrane. Accordingly, the inventors have recognized and appreciated that for some applications, the radial thermal distribution may introduce errors in the detection and quantization of radiative heat flow. Therefore, for some applications, the inventors have developed thermal sensors that include radial thermal detectors configured to determine a radial thermal distribution of the plurality of thermal detection regions and the plurality of thermal reference regions, which may be used to correct for errors caused by the radial thermal distribution.

FIG. 11 illustrates a perspective view of an example thermal sensor 1100 with radial thermal detectors, in accordance with some embodiments. Thermal sensor 1100 includes first thermal detection region 1102, second thermal detection region 1104, first thermal reference region 1106, second thermal reference region 1108, first array of thermocouples 1110, second array of thermocouples 1116, third array of thermocouples 1112, and fourth array of thermocouples 1114. In some embodiments, thermal sensor 1100 may be configured similarly as thermal sensor 1000, however thermal sensor 1100 further includes radial thermocouples.

As shown in FIG. 11, thermal sensor 1100 includes radial signal thermocouples configured to detect-within the first and second thermal detection regions 1102 and 1104, respectively-radial thermal distributions of membrane 1122. For example, thermal sensor 1100 includes first radial signal thermocouples 1118 in first thermal detection region 1102 and second radial signal thermocouples 1120 in second thermal detection region 1104.

Additionally, thermal sensor 1100 may further include radial reference thermocouples configured to detect-within the first and second thermal reference regions 1106 and 1108, respectively-radial thermal distributions. For example, thermal sensor 1100 may include first radial reference thermocouples under the reflective layers of the first thermal reference region 1106 and second radial reference thermocouples under the reflective layers of the second thermal reference region. The radial reference thermocouples may be configured in a similar geometric arrangement as the radial signal thermocouples, e.g., between reference junction blocks in the thermal reference regions. Accordingly, the radial reference thermocouples may be aligned approximately perpendicular to the axis of the radial signal thermocouples, in accordance with some embodiments.

In some embodiments, an additional thermocouple or array of thermocouples may be configured to detect a thermal differential between a portion of the membrane 1122 and the frame of the sensor.

In some embodiments, the thermal detection regions and the thermal reference regions may be configured with mirror-symmetry. For example, in the illustrated embodiments of FIG. 11, the thermal sensor may be configured in a square shape. Accordingly, the junction blocks may be configured radially along diagonal lines. In some embodiments, the thermal sensor may be configured in a square shape with a different arrangement of the junction blocks. For example, the junction blocks, and corresponding thermal detection and reference regions, may be configured radially along horizontal and/or vertical centerlines of the sensor.

In some embodiments, the sensor may be configured in other symmetries such that thermal detection junction blocks may have similar thermal distributions to each other, and such that the thermal reference junction blocks may have similar thermal distributions to each other. For example, points and/or lines of geometric symmetry may be used for the arrangement of junction blocks and the corresponding detection or reference regions.

The inventors have recognized and appreciated that for some applications, using angled thermocouples may decrease errors caused by the thermal distribution across the substrate. As the voltage produced by thermocouples is proportional to the difference in temperature between its hot junction and its cold junction, temperature fluctuations which include local minima or maxima can generate errors in the overall voltage produced by the thermocouples. Accordingly, for some applications, the inventors have developed thermal sensors where each thermocouple, of an array of thermocouples, includes one or more bends between the hot junction and the cold junctions. As a result, in some configurations, the middle portions of the thermocouples may experience a constant, or more stable, temperature along their length; thus, mitigating the generation of local minima or maxima along the length of the thermocouples.

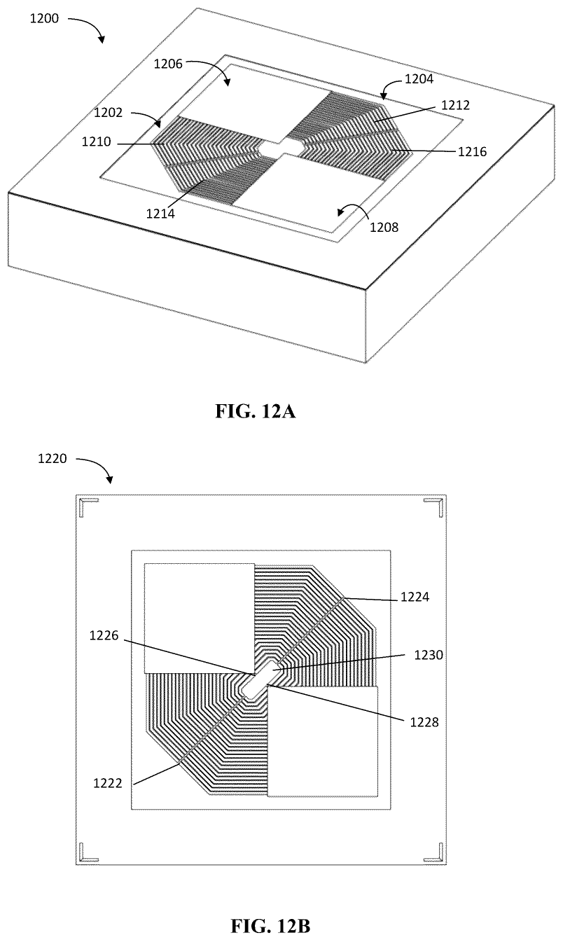

FIG. 12A illustrates a perspective view of an example thermal sensor 1200 with angled thermal detectors, in accordance with some embodiments. Thermal sensor 1200 includes first thermal detection region 1202, second thermal detection region 1204, first thermal reference region 1206, and second thermal reference region 1208. As shown in FIG. 12A, the first array of thermocouples 1210 and second array of thermocouples 1214 are configured detect thermal differentials between the first thermal detection region and each of the first and second thermal reference regions, respectively. Additionally, the third array of thermocouples 1212 and the fourth array of thermocouples 1216 are configured to detect thermal differentials between the second thermal detection region and each of the first and second thermal reference regions, respectively.

In some embodiments, the thermal sensor may include greater than or equal to four regions, or pixels, in any suitable arrangement. For example, the thermal sensor my include four regions, or pixels, on a square die. As another example, the thermal sensor may include eight regions, or pixels, on a square die. As another example, the thermal sensor may include twelve regions, or pixels, on a square die. As yet another example, the thermal sensor may include more than twelve regions, or pixels, on a square die. In some embodiments other shaped dies may be used. For example, a hexagonal die may be used rather than a square die. In other embodiments, other numbers of regions, or pixels, and/or different shaped dies may be used, as aspects of the technology described herein are not limited in this respect.

The plurality of arrays of thermocouples may be arranged in a polygonal shape (e.g., a square, pentagon, hexagon, octagon, etc.). As shown in FIG. 12A, each thermocouple, of the first array of thermocouples 1210, includes one bend between the signal junction (hot junction) and the reference junction (cold junction). The angle of the bend may be measured as the exterior angle. In some embodiments, the bend is at an angle between 20-80 degrees. In some embodiments, the bend is at an angle between 30-60 degrees. In some embodiments, the bend is between 40-50 degrees. For example, the angle may be 30, 45, or 60 degrees. Additionally, as shown in FIG. 12A, each thermocouple of the second, third, and fourth arrays of thermocouples 1014, 1212, and 1216 are configured with the same, or approximately the same, bend as the first array of thermocouples 1210.

In addition to including angled thermal detectors, for some applications, the symmetry of the thermal detections may be distorted such that the middle portions of the thermocouples may experience a constant, or more stable, temperature along their length; thus, mitigating the generation of local minima or maxima along the length of the thermal sensors.

FIG. 12B illustrates a top view of an example thermal sensor 1220 with angled thermal detectors, in accordance with some embodiments. Thermal sensor 1220 includes the same components as thermal detector 1200. As shown in FIG. 12B, each thermocouple of the plurality of arrays of thermocouples includes two bends between the signal junction and the reference junction. In addition to the number of bends, the geometric arrangement of the plurality of arrays of thermocouples may be described by the positioning of the signal junction blocks 1222 and 1224 for the first and second thermal detection regions, respectively, and the positioning of the reference junction blocks 1226 and 1228 for the first and second thermal reference regions, respectively.

In some embodiments, the spacing between first signal junction block 1222 and second signal junction block 1224 across central region 1230, as measured as the distance between the innermost (e.g., closest to the center of the sensor substrate) junctions of the signal junction blocks, is larger than the spacing between first reference junction block 1226 and second reference signal junction 1228. For example, the spacing between the signal junction blocks 1222 and 1224 may be approximately twice the spacing between reference junction blocks.

As shown in FIG. 12B, the difference in the spacing between the signal junction blocks and the reference junction blocks may distort the symmetry of the plurality of arrays of thermocouples. For example, the thermocouples, in the plurality of arrays of thermocouples, may be elongated along the detection axis, e.g., the axis along which signal junction blocks 1222 and 1224 are disposed.

The angle of the bend may be measured as the exterior angle. In some embodiments, the bend is at an angle between 20-80 degrees. In some embodiments, the bend is at an angle between 30-60 degrees. In some embodiments, the bend is between 40-50 degrees. For example, the angle may be 30, 45, or 60 degrees. As shown in FIG. 12B, the plurality of arrays of thermocouples may be arranged into a polygonal shape, such as an octagon.

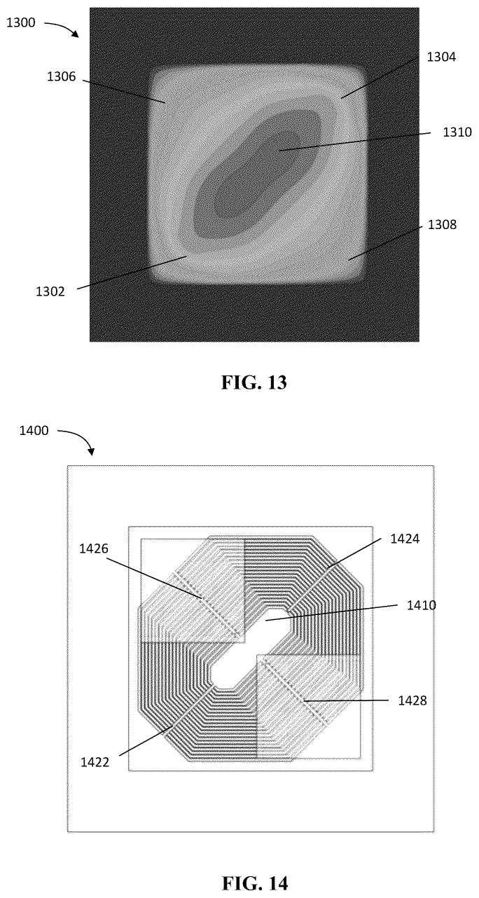

FIG. 13 illustrates a plot showing temperature distribution resulting from incoming radiation of a symmetrical thermal sensor without absorbing layers. Temperature plot 1300 corresponds to the temperature distribution resulting from heat flow to a symmetric thermal sensor, such as the sensor shown in FIG. 12A. Regions 1302 and 1304 correspond to the thermal distributions in the thermal detection regions of the sensor and regions 1306 and 1308 correspond to the thermal distributions in the thermal reference regions. As shown in FIG. 13, the temperature in the central region 1310 of temperature plot 1300 is elongated towards the thermal detection regions.

Accordingly, as described above with reference to FIGS. 12A and 12B, for some applications the symmetry of the thermal detections may be distorted to mitigate errors arising from the temperature gradients on the substrate.

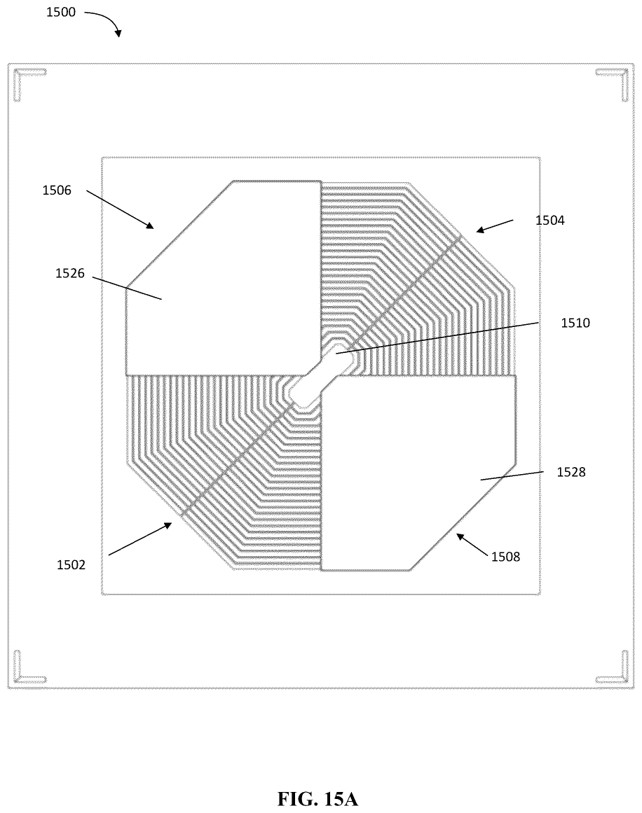

FIG. 14 illustrates a top view of an example thermal sensor 1400 with a spatial offset of thermal detectors, in accordance with some embodiments. As shown in FIG. 14, the symmetry of the plurality of thermocouple arrays is distorted such that the spacing between the first signal junction block 1422 and the second signal junction block 1424 is larger than the spacing between the first reference junction block 1426 and the second reference junction block 1428. The difference in spacing between the signal junction blocks and the reference junction blocks distorts the symmetry of the plurality of thermocouple arrays. In some embodiments, the distortion of the symmetry of the plurality of thermocouple arrays may be configured to be proportional to the elongation of the temperature distribution on the thermal sensor, such as the elongation illustrated in FIG. 13.

In some embodiments, the thermocouples, in the plurality of arrays of thermocouples, may be elongated along the detection axis across the central region 1410, e.g., the axis along which signal junction blocks 1422 and 1424 are disposed, such that the spacing between signal junction blocks is 1-2 times as large as the spacing between reference junction blocks. In some embodiments, the thermocouples may be elongated such that the spacing between signal junction blocks is 2-3 times as large as the spacing between reference junction blocks. In some embodiments, the thermocouples may be elongated such that the spacing between signal junction blocks is 3-4 times as large as the spacing between reference junction blocks. In some embodiments, the thermocouples may be elongated such that the spacing between signal junction blocks is 4-5 times as large as the spacing between reference junction blocks.

The inventors have recognized and appreciated that the high thermal conductivity of the metallic reflective layers, the shape and positioning of the reflective layers may impact the thermal gradients across the substrate. Accordingly, for some applications, the inventors have developed thermal sensors with reflective layers shaped to conform to a desired thermal distribution across the thermal sensor substrate. For example, shaping the reflective layers to correspond with the shape of the underlying thermopiles (e.g., thermocouple arrays) may reduce heat drain through the reflective layers to the edges of the membrane, thus reducing thermal distortion.

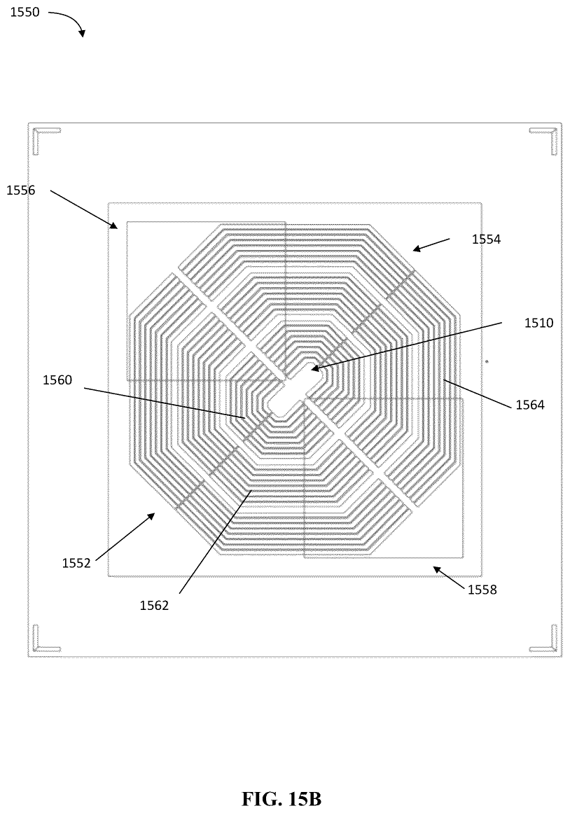

FIG. 15A illustrates a top view of an example thermal sensor 1500 with shaped reflective layers, in accordance with some embodiments. Thermal sensor 1500 includes first and second thermal detection regions 1502 and 1504 configured with a plurality of thermocouple arrays, including angled thermocouples, as described above in connection with FIGS. 12A-14. Thermal sensor 1500 further includes thermal reference regions 1506 and 1508 which include reflective layers 1526 and 1528, respectively. The central and peripheral portions of the reflective layers which are shaped to correspond with the polygonal shape of the underlying thermocouple arrays.

In some embodiments, the plurality of thermocouples is configured in an octagonal thermopile structure. Accordingly, the corresponding reflective layers for the thermal reference region may be shaped such that they correspond to the underlying octagonal thermopile structure. For example, reflective layers 1526 and 1528 are diamond shaped to correspond with the octagonal shape of the thermal sensor.

As described above in connection with FIG. 11, radial thermal gradients may cause errors in the detection and quantization of radiative heat flow. Therefore, the inventors have developed concentric thermopile structures that may be read out separately or in groups to mitigate the impact of radial thermal gradients or the heat flow detection and quantization.

FIG. 15B illustrates a top view of an example thermal sensor 1550 with concentric thermopiles, in accordance with some embodiments. Thermal sensor 1550 includes first thermal detection region 1552, second thermal detection region 1554, first thermal reference region 1556, and second thermal reference region 1558. The arrays of thermocouples are arranged in a polygonal shape as described above with reference to FIGS. 12A-14. The arrays of thermocouples are further arranged into concentric thermopiles such that the voltage and/or current output of a sub-array of the thermocouples can be read out separately or in groups to mitigate the impact of radial thermal gradients of the signal produced by the thermocouple arrays.

As shown in FIG. 15B, the arrays of thermocouples are grounded into a central thermocouple 1560, a middle thermocouple 1562, and an outer thermocouple 1564.

Accordingly, the thermal differentials can be measured as a function of their distance from the central region of the substrate 1510. Based on the differences between the thermal differentials measured from the concentric thermocouples 1560, 1562, and 1564 a radial thermal gradient may be corrected for in detecting and quantifying the radiative heat flow. In some embodiments, the concentric thermocouples may each be further partitioned into four respective thermopiles such that the thermal differential between a single thermal determination region and a single thermal reference region can be determined at each a central, middle, and outer thermopile.

The inventors have recognized and appreciated that while there may be challenges associated with fabricating absorbing layers such that the thermal properties are homogeneous, as described above, these challenges may be mitigated by incorporating nanostructured absorber and reflector layers. In some embodiments, nanostructuring such as through the creation of periodic or quasi-periodic structures on a substrate may be used to make surface reflective or absorbing. For example, photonic crystals use periodic and/or quasi-periodic structures to produce highly reflective or absorbing surfaces. Photonic crystals utilize the constructive and destructive interference of radiation produced by the nanostructured pattern to produce the reflective and/or absorbing properties at wavelengths of interest. As the reflective and absorbing properties are determined by the patterning, the same material, having different nanostructured patterns, may be used both for the reflective layers and the absorbing layers. Accordingly, the thermal properties of the absorbing and reflective layers may be the same, or almost the same, mitigating the generation of thermal gradients through the asymmetric conduction of heat to the membrane. Therefore, the inventors have developed embodiments, for some applications, which incorporate nanostructured absorbing and reflective layers.

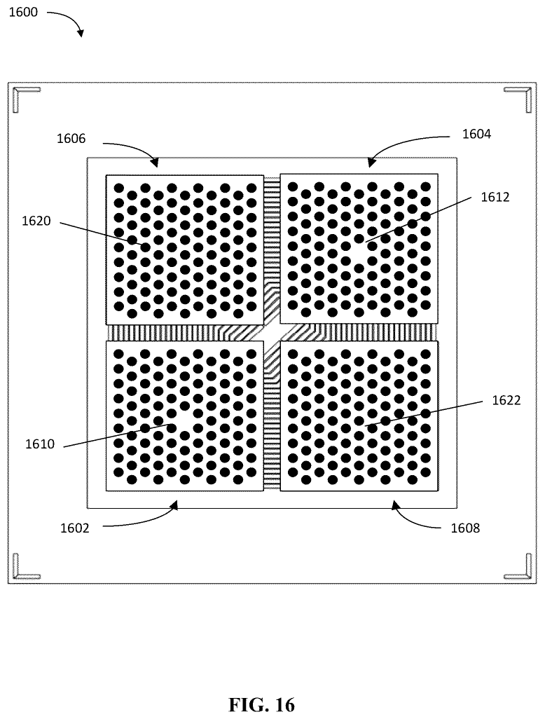

FIG. 16 illustrates a top view of an example thermal sensor 1600 with nanostructured absorbing and reflective layers, in accordance with some embodiments. Thermal sensor 1600 includes first thermal detection region 1602, second thermal detection region 1604, first thermal reference region 1606, and second thermal reference region 1608. As shown in FIG. 16, nanostructured absorbing materials are disposed on thermal detection regions 1602 and 1604, and nanostructured reflecting materials are disposed on thermal reflecting regions 1606 and 1608. The nanostructure absorbing materials 1610 and 1612 are configured with a pattern of holes in a metallic layer such that the layer absorbs thermal radiation. The nanostructured reflecting materials 1620 and 1622 are configured with a pattern of holes in a metallic layer such that the layer reflects thermal radiation.

In some embodiments, the nanostructure may include a pattern of holes or apertures periodically positioned across the patterned substrate. In some embodiments, a pattern of trenches or pillars may be periodically positioned across the patterned substrate.

In some embodiments, the nanostructured absorbing and/or reflecting materials may be configured to absorb and/or reflect specific wavelengths. For example, the absorbing materials may be configured to absorb a wavelength of interest but to reflect other wavelengths of radiative heat. The reflecting materials may be designed to reflect a broad spectrum of wavelengths of radiative heat.

The sensors, systems, and components described herein may be implemented in connection with methods of detecting thermal radiation (e.g., radiative energy) and/or determining a quantity of thermal radiation received by a thermal sensor. Accordingly, the thermal sensor may be configured for a given percentage of radiative energy received by the sensor, within a wavelength range of interest, to be converted to heat. The given percentage of radiative energy converted to heat may be controlled through the configuration of the thermal detection regions and the thermal reference regions. For example, the percentage of radiative energy converted to heat may be controlled by configuring reflective layers to have a given reflectivity with a corresponding surface area on the sensor and further configuring absorbing layers to have a given absorption with a corresponding surface area on the sensor.

According to some aspects of the technology described herein, methods of using the thermal sensor may determine a quantity of radiative energy received by the thermal sensor. In some embodiments, the method may include detecting a thermal differential between thermal detection regions and thermal reference regions and determining the quantity of radiative energy received based on the thermal differential between the thermal detection regions and the thermal reference regions. For example, the thermal detection regions may undergo a temperature change proportional to the quantities of radiative and non-radiative thermal energy. By contrast, the thermal reference regions may undergo a temperature change proportional to the quantity of non-radiative thermal energy. Accordingly, a thermal differential signal-such as a thermocouple voltage-proportional to the difference in temperature between the thermal detection and thermal reference regions may isolate a signal proportional to the difference in the sensitivity of the thermal detection and thermal reference regions to radiative thermal energy, as described further herein with reference to FIGS. 1C-1E.

In some embodiments, further thermal detectors may be configured to determine a radial thermal distribution of the thermal sensor. For example, thermocouples configured radially to detect a thermal differential between a central region of the substrate and a peripheral region of the substrate may be used to detect a thermal distribution across the thermal sensor. Based on the thermal distribution across the thermal sensor, the signals produced from the thermal sensors in the thermal detection regions and thermal reference regions may be calibrated for their respective sensitivity to received radiative energy based on their geometric position on the thermal sensor and the thermal distribution.

In some embodiments, further thermal detectors may be configured to determine a thermal differential between the membrane of the thermal sensor and a frame of the substrate. The frame of the substrate may be configured as a thermal sink which may be considered to have a near constant temperature during operation of the sensor. Accordingly, a thermal differential between the membrane of the thermal sensor and the frame may be used to determine the temperatures detected by the thermal differential of respective thermal sensors in the thermal detection regions and thermal reference regions.

In some embodiments, the method of operating a thermal sensor, comprises: detecting, using a first array of thermocouples, a first thermal differential between a first thermal detection region and a first thermal reference region of a substrate of the thermal sensor, wherein the first thermal detection region comprises a first signal junction block; the first thermal reference region comprises a first reference junction block; and the first array of thermocouples is configured to probe a temperature of the first signal junction block relative to the first reference junction block, such that an electrical signal detected from the first array of thermocouples is indicative of the first thermal differential between the first signal junction block and the first reference junction block; and determining the quantity of radiative energy received based on the first thermal differential between the thermal detection region and the thermal reference region.

In some embodiments, determining the quantity of radiative energy received is further based on a second thermal differential and wherein detecting the second thermal differential comprises: detecting, using a second array of thermocouples, the second thermal differential between a second thermal detection region and a second thermal reference region of the substrate of the thermal sensor, wherein: the second thermal detection comprises a second signal junction block; the second thermal reference region comprises a second reference junction block; and the second array of thermocouples being configured to probe a temperature of the second signal junction block relative to the second reference junction block, such that an electrical signal detected from the second array of thermocouples is indicative of the second thermal differential between the second signal junction block and the second reference junction block.

In some embodiments, determining the quantity of radiative energy received is further based on a third and fourth thermal differential, and wherein detecting the third and fourth thermal differentials comprises: detecting, using a third array of thermocouples, the third thermal differential between the first thermal detection region and the second thermal reference region; and detecting, using a fourth array of thermocouples, the fourth thermal differential between the second thermal detection region and the first thermal reference region.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The phrase “and/or,” as used herein in the specification and in the claims, should be understood to mean “either or both,” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The terms “substantially,” “approximately,” and “about” may be used to mean within +20% of a target value in some embodiments, within +10% of a target value in some embodiments, within +5% of a target value in some embodiments, and yet within +2% of a target value in some embodiments. The terms “approximately” and “about” may include the target value.

The indefinite articles “a” and “an,” as used herein in the specification and in the claims, unless clearly indicated to the contrary, should be understood to mean “at least one.”

As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phrascology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

It will be apparent to those skilled in the art that various modifications and variations can be made to the structure of the technologies described herein without departing from the scope or spirit of the disclosure. In view of the foregoing, it is intended that the present disclosure include modifications and variations of technology described herein provided they fall within the scope of the following claims and their equivalents.

1. A thermal sensor, comprising:
a thermal detection region of a sensor substrate;
a thermal reference region of the sensor substrate; and
an array of thermocouples configured to detect a thermal differential between the thermal detection region and the thermal reference region.

2. The thermal sensor of claim 1, wherein:
the thermal detection region comprises a first signal junction block;
the thermal reference region comprises a first reference junction block; and
the array of thermocouples, wherein each thermocouple in the array of thermocouples is configured to probe a temperature of the first signal junction block relative to the first reference junction block.

3. The thermal sensor of claim 2, wherein:
the first signal junction block comprises a plurality of thermoelectric junctions disposed along a first line radially extending from a central region of the substrate; and
the first reference junction block comprises a plurality of thermoelectric junctions disposed along a second line radially extending from the central region of the substrate.

4. The thermal sensor of claim 3, wherein:
the array of thermocouples is a first array of thermocouples of a plurality of arrays of thermocouples;
the thermal detection region is a first thermal detection region of a plurality of thermal detection regions; and
the thermal reference region is a first thermal reference region of a plurality of thermal reference regions.

5. The thermal sensor of claim 4, wherein:
a second thermal detection region of the plurality of thermal detection regions, comprises a second signal junction block disposed along a third line radially extending from the central region of the substrate, the third line being axially aligned with the first line; and
a second thermal reference region of the plurality of thermal reference regions, comprises a second reference junction block disposed along a fourth line radially extending from the central region of the substrate, the fourth line being axially aligned with the second line.

6. The thermal sensor of claim 5, further comprising:
a second array of thermocouples configured to probe a temperature of the first signal junction block relative to the second reference junction block;
a third array of thermocouples configured to probe a temperature of the second signal junction block relative to the first reference junction block; and
a fourth array of thermocouples configured to probe a temperature of the second signal junction block relative to the second reference junction block.

7. The thermal sensor of claim 6, further comprising:
radial signal thermocouples configured to detect, within the plurality of thermal detection regions, a first radial thermal differential between the central region of the substrate and a peripheral region of the substrate; and
radial reference thermocouples configured to detect, within the plurality of thermal reference regions, a second radial thermal differential between the central region of the substrate and the peripheral region of the substrate.

8. The thermal sensor of claim 6, wherein a separation between the first signal junction block and the second signal junction block across the central region is larger than a separation between the first reference junction block and the second reference junction block across the central region.

9. The thermal sensor of claim 2, further comprising a reflective layer disposed on the thermal reference region.

10. The thermal sensor of claim 9, further comprising an absorbing layer disposed on the thermal detection region.

11. (canceled)

12. A method of operating a thermal sensor to determine a quantity of radiative energy received by the thermal sensor, the method comprising:
detecting, using a first array of thermocouples, a first thermal differential between a first thermal detection region and a first thermal reference region of a substrate of the thermal sensor, wherein:
the first thermal detection region comprises a first signal junction block;
the first thermal reference region comprises a first reference junction block; and
the first array of thermocouples is configured to probe a temperature of the first signal junction block relative to the first reference junction block, such that an electrical signal detected from the first array of thermocouples is indicative of the first thermal differential between the first signal junction block and the first reference junction block; and
determining the quantity of radiative energy received based on the first thermal differential between the thermal detection region and the thermal reference region.

13. The method of operating the thermal sensor of claim 12, wherein determining the quantity of radiative energy received is further based on a second thermal differential and wherein detecting the second thermal differential comprises:
detecting, using a second array of thermocouples, the second thermal differential between a second thermal detection region and a second thermal reference region of the substrate of the thermal sensor, wherein:
the second thermal detection comprises a second signal junction block;
the second thermal reference region comprises a second reference junction block; and
the second array of thermocouples being configured to probe a temperature of the second signal junction block relative to the second reference junction block, such that an electrical signal detected from the second array of thermocouples is indicative of the second thermal differential between the second signal junction block and the second reference junction block.

14. The method of operating the thermal sensor of claim 13, wherein determining the quantity of radiative energy received is further based on a third and fourth thermal differential, and wherein detecting the third and fourth thermal differentials comprises:
detecting, using a third array of thermocouples, the third thermal differential between the first thermal detection region and the second thermal reference region; and
detecting, using a fourth array of thermocouples, the fourth thermal differential between the second thermal detection region and the first thermal reference region.

15. The method of operating the thermal sensor of claim 14, further comprising:
detecting a radial signal thermal differential between a central region of the substrate and a peripheral region of the substrate within the thermal detection region;
detecting a radial reference thermal differential between the central region of the substrate and the peripheral region of the substrate within the thermal reference region; and
determining an error correction based, at least in part, on the radial signal thermal differential between the central region of the substrate and the peripheral region of the substrate.

16. The method of operating the thermal sensor of claim 12, wherein:
the first signal junction block comprises a plurality of thermoelectric junctions disposed along a first line radially extending from a central region of the substrate; and
the first reference junction block comprises a plurality of thermoelectric junctions disposed along a second line radially extending from the central region of the substrate.

17. A thermal sensor system, comprising:
a thermal sensor comprising:
a thermal detection region of a sensor substrate;
a thermal reference region of the sensor substrate; and
an array of thermocouples configured to detect a thermal differential between the thermal detection region and the thermal reference region; and
a housing configured to support the thermal sensor within the housing and beneath a windowed aperture of the housing, wherein the windowed aperture is configured such that radiative energy may transmit through the windowed aperture and be received by the thermal sensor.

18. The thermal sensor system of claim 17, wherein:
the thermal detection region comprises a first signal junction block, the first signal junction block comprising a plurality of thermoelectric junctions disposed along a first line radially extending from a central region of the substrate;
the thermal reference region comprises a first reference junction block, the first reference junction block comprises a plurality of thermoelectric junctions disposed along a second line radially extending from the central region of the substrate; and
the array of thermocouples, wherein each thermocouple in the array of thermocouples is configured to probe a temperature of the first signal junction block relative to the first reference junction block.

19. The thermal sensor system of claim 18, wherein:
the thermal detection region is a first thermal detection region of a plurality of thermal detection regions, and the plurality of thermal detection regions further comprises a second thermal detection region, comprising a second signal junction block disposed along a third line radially extending from the central region of the substrate, the third line being axially aligned with the first line;
the thermal reference region is a first thermal reference region of a plurality of thermal reference regions, and the plurality of thermal reference regions further comprises a second thermal reference region, comprising a second reference junction block disposed along a fourth line radially extending from the central region of the substrate, the fourth line being axially aligned with the second line; and
the array of thermocouples is a first array of thermocouples of a plurality of arrays of thermocouples, and the plurality of arrays of thermocouples further comprising:
a second array of thermocouples configured to probe a temperature of the first signal junction block relative to the second reference junction block;
a third array of thermocouples configured to probe a temperature of the second signal junction block relative to the first reference junction block; and
a fourth array of thermocouples configured to probe a temperature of the second signal junction block relative to the second reference junction block.

20. The thermal sensor system of claim 19, further comprising:
radial signal thermocouples configured to detect, within the plurality of thermal detection regions, a first radial thermal differential between the central region of the substrate and a peripheral region of the substrate; and
radial reference thermocouples configured to detect, within the plurality of thermal reference regions, a second radial thermal differential between the central region of the substrate and the peripheral region of the substrate.

21. The thermal sensor system of claim 17, further comprising a reflective layer disposed on the thermal reference region, and an absorbing layer disposed on the thermal detection region, wherein the absorbing layer is nanostructured to provide for absorption of the radiative energy, and the reflective layer is nanostructured to provide for reflection of the radiative energy.
